(19) United States
(12) Patent Application Publication
(10) Pub. No.: US 2003/0167666 A1
(43) Pub. Date: Sep. 11, 2003

(54) Fixed character LED display device

(76) Inventor: Richard A. Close JR., Farmington Hills, MI (US)

Correspondence Address: Richard A. Close, Jr., 30769 Sudbury Ct., Farmington Hills, MI, 48331, US

(21) Appl. No.: 10/094,831

(22) Filed: Mar. 11, 2002

(51) Int. Cl. G09F 3/04; G09F 7/00

(52) U.S. Cl. 40/452; 40/597

(57) ABSTRACT

The present invention relates to a novel lighting display system for numerous uses. Consisting of the following members. An enclosure with a transparent front face, containing a channel along its length for locating and retaining an assembly of circuit boards with alphanumeric characters. The circuit boards have light emitting diodes (LEDs) arranged to form alphanumeric characters. The circuit board characters are connected electrically in series or parallel and can be arranged to form an illuminated message, word, or series of numerals.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The present invention relates generally to a character display systems and, in particular, to a configurable fixed character light emitting diode (LED) alpha numeric display system. Alphanumeric character elements are connected through an electromechanical means to form words or numbers. In addition, multiple rows of alphanumeric elements can be used to display longer fixed messages. The display character elements may be housed in an enclosure with a transparent front panel. The enclosure may also be sealed for outdoor applications.

There are many examples of LED's display signs currently in manufacturer. One type of LED sign is a programmable or scrolling message display sign. These signs offer flexibility in the programmable message they can display. They include a microprocessor and electronics for controlling the scrolling character display. The display must also employ a LED matrix array for the flexible character generation. This makes these signs complicated, less reliable and more expensive than they need to be to display a fixed message. Another type of LED sign is a fixed word sign. These signs are made from a single circuit board with the LED's arranged in the form of letters to make a word. An example of this sign type is an EXIT sign. These signs are lower in cost, but are not made of characters that can be easily reconfigured to form personalized signs.

In U.S. Pat. No. 4,028,828, the alphanumeric character boards use incandescent bulbs mounted on circuit boards to form the alphanumeric characters. These circuit boards are encapsulated in individual enclosures with transparent front faces. Electrical connection pins protrude from the encapsulation. Devices, which use incandescent bulbs, use significantly more power with a much shorter life than LED light sources. In addition, enclosing the circuit boards in individual enclosures adds cost compared to placing the circuit boards in a single enclosure. The pins protruding from the encapsulation also require the enclosure to be used indoors or environments, which would not promote corrosion and failure.

There are many examples of message signs, which are used to convey simple messages to people passing by. Examples of these types of signs are street addresses on houses or businesses, menu displays, personalized license plates with people or business names, various information signs like OPEN, CLOSED, EXIT, etc. These signs are typically made of a mechanical alphanumeric character arranged and attached to a substrate to hold them in place. It is often desirable for these signs to be visible both during the daylight and when it's dark at night. To make them visible during daylight the characters are normally colored in a contrasting color from the substrate the characters are displayed on. For night viewing, some signs employ a device for lighting the characters. One type of lighting method is to use an integral or external light source such as a floodlight or light bulb to light the characters. A second type of sign used for night viewing uses translucent characters placed on a transparent substrate. An opaque background then borders the characters. A painting or screening process it typically used. A light source is placed behind the substrate, light passes through the translucent area and is blocked by the opaque areas causing the characters to light at night. Many other types of signs rely on external sources of light to reflect light from the characters, such as a motor vehicle's headlight to light the sign for night viewing. In addition, most of these signs require custom artwork and can be expensive to build. In some cases the signs do not have an appropriate amount of contrast for daylight visibility and have very poor nighttime visibility. Other sign display apparatus have very poor night time visibility even when some type of external projected light source is used to reflect from the characters. LED signs have the added benefit of high intensity, long life and low power consumption when compared to incandescent lit signs.

It is desirable to provide an inexpensive sign that can be easily built from alphanumeric character components and assembled into words or numbers. It is desirable to provide a means for lighting the sign with a high character contrast that is visible in daylight or in the dark. It is desirable for the sign to have a light source, which has a long life. It is desirable to connect the sign to a readily available DC or AC power sources. It is desirable to have the power consumption of the sign be as low as possible when the characters are energized.

It is an object of the invention; therefore, to provide individual circuit boards with the alphanumeric characters formed from LED's placed in the appropriate pattern to form the character. It is also an object of the invention that the circuit boards be arranged with the appropriate characters to form words and/or numbers. It is also an object of the invention that the LED's used in the characters may optionally be different colors and patterns to offer custom looks for personalized signs. It is also an object of the invention that the circuit boards be connected electrically with a circuit either on the circuit boards or with an external electrical bus bar. It is also an object of the invention that the circuit boards be energized by an AC or DC power source.

It is another object of the invention to provide an enclosure for mounting and protecting the circuit board. It is also an object of the invention for the housing to have a transparent front face to view the LED characters. It is also an object of the invention for the enclosure to be made of as few pieces as possible. The preferred embodiment is a clear plastic extrusion or co-extrusion with caps that seal the ends. It is also an object of the invention that the enclosure mechanically supports and retains the character circuit boards.

It is another object of the invention to design the end cap panels to offer a variety of mounting configurations. It is also an object of the invention for the end panels to be configured in such a manner as to allow enclosures to be stacked and mounted together to offer multiple line signs. It is also an object of this invention that the end panels be configured in such a manner as to allow the enclosure to be hung or attached to other brackets or posts.

It is another object of the invention to provide alternative end panels for different applications of the display device. One of these unique applications would allow the easy mounting of the display and enclosure in the license plate mounting area of a motor vehicle. The end panel, with this application specific design, would mount to the enclosure the same was as the other end panels. The end panels would then have flanges which orient the mounting holes to match the hole spacing and configuration of an automotive type license plate mount. A second type for a custom application end panel, would be an end panel, which incorporates a stake or tine for directly affixing the display enclosure to the ground. This type of display device with the stake end panels may be used in front of a house or business, which would show a name or address and may be powered by a low voltage lighting system power source.

It is another object of the invention to provide an optional enclosure that would mount the character circuit boards in multiple rows to form multi-line signs. It is also an object of this invention that the enclosure would allow easy insertion and removal of the character circuit boards to allow easy reconfiguration of the message.

### BRIEF SUMMARY OF THE INVENTION

The present invention solves the problems of the prior art and accomplishes the objectives noted above by providing a novel, configurable, fixed character, light emitting diode (LED), alpha numeric message display system. The message display system consists of individual circuit boards. Each circuit card has LED's placed on the surface with their light source projecting light away from the plane of the circuit board and in the arrangement of an alphanumeric character. The LED's are arranged in a pattern, which represents numerals, letters, characters or other or symbols. Each circuit card has an integral bus bar, for busing power (+) and ground (−) from one circuit board to the next. The circuit board also has details, which electromechanically connect the boards to one another. On each circuit board, the LED's are connected to the integral power and ground bus through a resistor to energize them at their rated voltage. The integral bus bars on the top and bottom of the circuit board transfer power from a central power connection along the circuit boards electrical conductors. Various characters can be combined to form an illuminated message, word, name or series of numerals (number).

The enclosure has a rectangular cross sectional shape with clear front face. The clear face allows the transmitted light from the LED's to pass through it while protecting the cricuti boards and LED's. The enclosure also includes features, which locate and retain the circuit boards. Integral screw bosses are formed in the corners of the enclosure for attaching end panels to the enclosure once the circuit board assembly is installed. Preferably, the walls of the screw aperture are of a smooth bore type and sized for the appropriate fastener. Alternatively, the screw boss may be shaped to fit various fastener profiles. The enclosure is preferably constructed of a plastic material that is transparent and easily extruded or molded. Optionally the enclosure may be of a two piece construction with a molded or extruded housing and a clear plastic front face. Importantly, the properties of the plastic material are such that they do not significantly degrade when exposed sunlight, cleaners and impacts from foreign objects. The plastic must also have the proper material properties that would allow the installation of a self-tapping screw. A plastic, such as, but not limited to, acrylic or polycarbonate may be ideal for this application.

The LED character circuit boards have details that allow them to be electromechanically connected to one another. The character boards are arranged in the proper order to form the desired words and numbers and then placed to abut one another. Conductive metal straps are than bolted, riveted or soldered to abutting boards to make the connection. Optionally an edge connection or circuit board header may be used to connect the circuit board characters. In different configurations, the LED circuit boards can be designed to work with AC or DC power. In the preferred configuration, the circuit boards are connected in parallel. The design voltage across the circuit boards determines how many LED's are placed in series. In 12 V DC design, up to five LED's would be placed in series with a resistor. Several parallel branches on a character circuit board may be required to form the desired character. In 110V AC system up to 35 LED's may be used in series with a resistor. Again parallel branches on a character circuit board may be required to for the desired character. A wiring harness is than attached to the last circuit board for bringing electrical power to the boards.

Many different types of power sources can be used to power the display device depending on the application. Character boards can be designed as described above for connecting directly to a AC power source. Character boards designed for 12 V system could be connected directly to an automotive 12 V power system or to a 12 V low voltage out door lighting system transformer. Optionally the 12 V display characters may be connected to a AC adapter transformer which supplies 12 V. In yet another application, the display device could be used in conjunction with a photovoltaic solar panel and a battery.

Depending on the enclosure construction, end panels are attached to each end of the enclosure, encapsulating the circuit board display characters within. The end panels fasten to the enclosure and may have a seal for use in applications with outdoor exposure. The end panels can be designed with different mounting details to fit various applications. The basic end panel includes details, which allow the display device to be hung or screwed to supports. When used in conjunction with large suction cubs, the display panels may be hung on almost any type of glass panel including automotive glass. The end panels also have details, which mechanically attach the enclosures allowing them to be stacked. Other end panel configurations are designed to directly attach the display device to the mounting points of an automotive type license plate mount. Still yet another configuration would allow the display device to be staked in the ground.

In the preferred embodiment, the size and shape of the characters and length of the message sign would be the appropriate length for displaying house address numbers. A second fabrication would make the characters the proper size and aspect ratio so as to fit and mount in the license plate area of a motor vehicle. This application may employ a special end panel, which would incorporate mounts to utilize the attaching holes for automotive license plates.

The present invention may be advantageously applied to any type of fixed alphanumeric display signs. Alternatively, the characters, enclosure and end cap sizes can be made larger or smaller to increase or reduce visibility from different distances. Different colored LED's may be used in any combination to create different colored signs. Furthermore, these LED signs may be used in many applications and for many purposes. Some of which are; house or business street address numbers, lighted personalized license plates, street names, menus, professional building directories and any other type of sign that would employ a fixed message. These LED signs may also be used to communicate information such as “OPEN”, “CLOSED”, “EXIT”, “CAUTION”, etc.

### BRIEF DESCRIPTION OF THE SEVERAL VIEWS OF THE DRAWING

The above, as well as other advantages of the present invention, will become readily apparent to those skilled in the art from the following detailed description of a preferred embodiment when considered in the light of the accompanying drawings in which:

FIG. 1 is a cross-sectional view of an LED display device showing the preferred embodiment of an extruded enclosure with the circuit board and LED's in accordance with present invention;

FIG. 2 is a perspective view of the LED display sign in FIG. 1 showing several circuit boards mechanically and electrically connected together. The circuit boards in this example show the numerals “1”, “2”, “3” and Letter “A”. The circuit boards are also connected to a wiring pigtail, which passes through the end panel. Alternatively the end panel my have a foam seal applied to the surface;

FIGS. 3 and 3′ are perspective views of an end panel, in accordance with the present invitation. FIG. 3 shows a partial cutaway with the seal removed.

FIG. 4 is a plan view of a circuit board display character in accordance with the present invention. It shows one of the many alphanumeric characters that could be configured on the circuit board.

FIG. 5 is a plan view of the electrical/mechanical connector in accordance with the present invention.

FIG. 6 is a fragmentary cross-sectional view taken along the line 5-5 in FIG. 4 showing two different methods for electrically and mechanically connecting the circuit boards. One is a conductive rivet, the other is a conductive bolt.

FIG. 7 is a fragmentary cross-sectional view taken along the line 5-5 in FIG. 4, which shows an alternative method for electomechanically connect the circuit boards. A jumper wire is shown soldered to two different circuit boards. For clarity, jumper wire is not shown in FIG. 4.

FIG. 8 is a perspective view of an optional angle-mounting bracket in accordance with the present invention;

FIG. 9 is a perspective view showing an alternative construction for an end panel, in accordance with the present invention, that would mount the display device to an automotive vehicle license plated mount. The end panel brackets position the mounting holes on the display device to align with their respective mounting points for a license plate;

FIG. 10 is a perspective view showing an alternative construction for the end panel that would mount the display device by staking it into the ground, in accordance with the present invention;

FIG. 11 is a cross-sectional view of the LED display sign showing an alternative construction for the present invention, it shows an extruded enclosure, separate clear lens, circuit board and LED's in accordance with present invention;

FIG. 12 is a fragmentary perspective view showing the extruded enclosure in the preferred embodiment.

### DETAILED DESCRIPTION OF THE INVENTION

For the purposes of promoting and understanding the principles of the invention, reference will now be made to the embodiments illustrated in the drawings and specific language will be used to describe the same. It will nevertheless be understood that no limitation of the scope of the invention is thereby intended. Such alterations and further modifications in the illustrated device, and such further applications of the principles of the invention as illustrated therein being contemplated as would normally occur to one skilled in the art to which the invention relates.

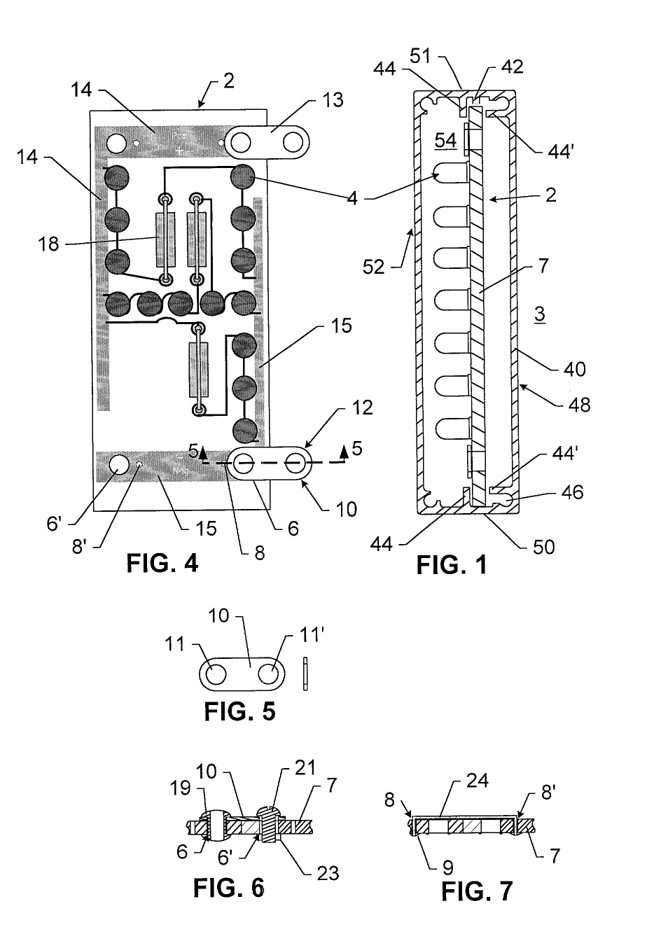

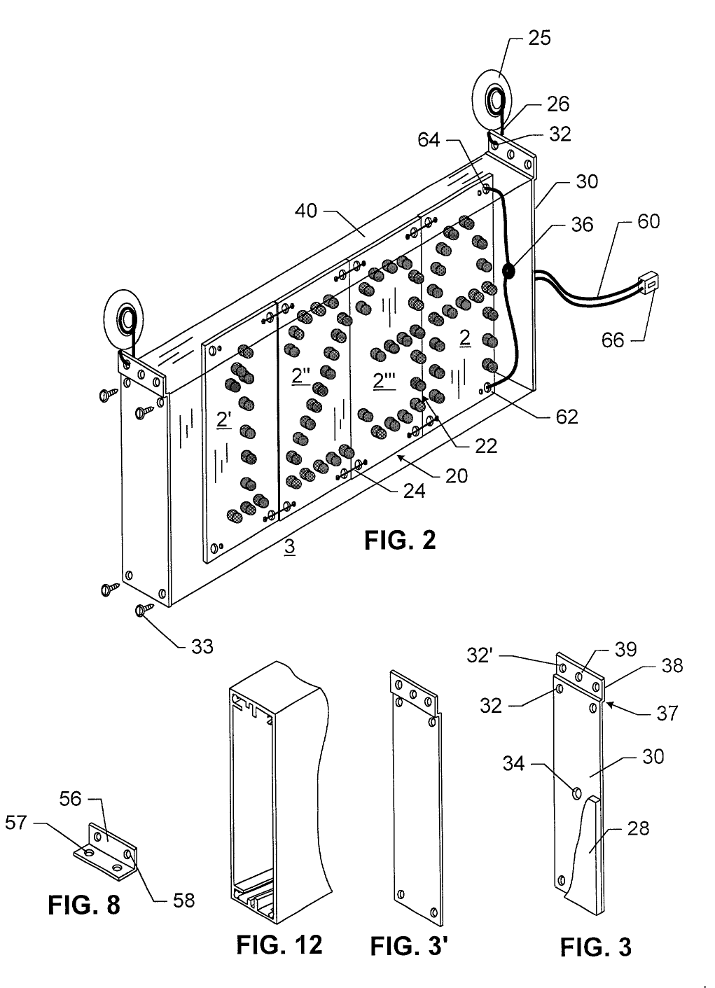

Referring in particular to FIGS. 1 and 2, there is shown a configurable character display device indicated generally at 3 according to the present invention. The display device 3 (FIG. 1) comprises an enclosure 40. The enclosure has a generally elongated rectangular shape, with a back wall 48, top wall 51, front wall 52 and a bottom wall 50, which are integrally connected and form a aperture 54 in which the circuit board display characters are located. Enclosure 40 includes circuit board locating walls 44, 44′ and 42, which extend from the top 51, bottom 50 and back wall 48, along the entire length of the enclosure. The channel created by the walls 44, 44′ and 42 cooperates with and locates the circuit board 7. Enclosure 40 also includes integral semicircular screw boss apertures 46 adapted to fit a typical threaded fastener 33 (FIG. 2). In the preferred construction, enclosure 40 is a transparent plastic extrusion. The extrusion can be cut to varying lengths to display different length messages. The extrusion may also be made in various sizes to accept small or large circuit board display characters 2. Clear acrylic or polycarbonates are typical materials that may be used in the construction of the enclosure.

Optionally the enclosure 40 could be made from any combination of multiple pieces for each of the walls. For example, FIG. 11 shows and enclosure made from two pieces, where the back wall 48, top wall 51 and bottom wall 50 are made from one extrusion, which include the details as described above, and a lens 53 which is made from a second piece. Upper channel 43 and lower channel 45 extend for the length. They cooperate and locate the lens 53.

Referring in particular to FIGS. 2 and 4, the configurable character display device also comprises individual circuit board display characters 2. The circuit board assemblies 2 have light emitting diodes (LED) 4 mounted on it's surface and are mechanically and electrically connected to the applicable electrical circuit path to energize the LED 4. The LED 4 (FIG. 1) are arranged on the circuit board to form a letter or number 2, 2′, 2″, 2′″. Any number of LED 4 may be used to form the individual characters. Small characters would normally use a fewer number of LED 4, while large characters would require more LED 4. Increased character resolution would also increase the number of LED 4 required. Character stoke widths may also be increased by placing LED 4 in close proximity to one another. The LED used to create a character may be one or more colors, or colors creating a different pattern in one, or across many characters. Each circuit board display character 2 has only one number character or one letter character on each circuit board display 2. The circuit board display characters 2 are electrically and mechanically connected to form names, words, numbers or combinations thereof.

In the preferred embodiment, the circuit board assembly 2 is manufactured from materials and processes, which are typically used in electrical circuit board design and fabrication. This does not preclude the circuit board assembly 2 being made from other processes such as stamped conductive circuits, which are inserted or molded into a substrate. The LED 4 terminals could be soldered, welded or staked to the metal traces. The circuit board 2 may also be made from a flexible printed circuit. The LED's 4 used to form the characters may alternatively be made using any of the typical constructions. Leaded parts with and without a lens may be used as well as surface mount components with or without a lens. The LED's 4 are typically placed in series with a resistor 18.

In addition to circuit board characters 2, a circuit board with a light sensor (not shown) may also be included in the circuit and only turn on the LED's at night.

Referring now to FIGS. 5, 6 and 7, there are several methods for electromechanically connecting the circuit boards 7. The circuit board 7, used in the circuit board display character 2, includes several different features, which facilitate many different ways for the circuit board display characters 2 to be electrically and/or mechanically interconnected. Bus bar mounting holes 6 and 6′ are included in each corner for mounting bus bar 10. Jumper wire mounting holes 8 and 8′ are also included in each corner for mounting jumper wire 24. In addition solder pads 9 are included on the backside of the circuit boards 7 for connecting to an external bus bar which can be made a part of the enclosure 40. Using a typical edge board connector (not shown) or header connector (not shown) with the mating connector on the respective abutting circuit board 7 the connection may also be made between the circuit boards 7.

When the circuit board display characters 2 abut one another as shown in FIG. 2, a electromechanical connector 10 or 24 is connected between the circuit board display characters 2. In the preferred embodiment, a small conductive bus bar 10 is used. In applications where the circuit board display characters 2 are connected electrically in series, two electromechanical connectors may be used, one for positive pole 13 and one for the negative pole 12. To connect consecutive circuit board display characters 2, the circuit board display characters 2 are positioned so they abut one another and are aligned at their top and bottom edges. A bus bar 10 is installed on the circuit board 7 so that its' integral holes 11 and 11′ align with their respective bus bar mounting holes 6 and 6′ in the circuit board 7. Two screws 21 and nuts 23, or rivets 19 are than placed through the holes and used to attach the bus bar 10 and circuit boards display characters 2. Optionally, in place of the bus bar 10 and fasteners, a jumper wire 24 could be used. The jumper wire 24, would be placed in it's respective jumper wire mounting holes 8 and 8′, then soldered or crimped to the circuit board 7. Consecutive circuit boards would than be electromechanically connected together until the desired word(s), name or number is complete to form the desired message sign. If a space is required between two consecutive boards, for example a space between words, the circuit boards can be spaced apart by using an elongated bus bar 10 or jumper wire 24. After the connection of the wiring harness 60, described below, the circuit board assembly slides into the circuit board locating channels created by walls 44, 44′ and 42 into the desired position.

An electric wiring harness 60 is connected at one end of the assembly of circuit board display characters 20. In the preferred embodiment, the wiring harness 60 has a ring terminal electromechanically attached to one end of each of the conductors. The other end of the wiring harness 60 has an electrical connector 66 for connecting the assembly of circuit board display characters 20 to an external power source. The wiring harness 60 passes through a hole 34 in the end panel 30. Optionally the wiring harness 60 may also pass through a seal 36, which seals the wire harness 60 to the end panel 30. The wiring harness positive conductor 64 is electromechanically connected to the positive circuit board conductor 14 using a rivet 19 or bolts 21 and nut 23, similar to the bus bar 10 attachment. The wiring harness conductors are electrically bonded through the bus bar mounting holes 6. The wiring harness negative conductor 62 is attached in a similar fashion to the negative circuit board conductor 15. Optionally the wiring harness 60 conductors may be attached directly to the circuit board 7 by eliminating the need for the ring terminals and soldering the conductors through the jumper wire holes 6. In the applications where a AC power source would be used to power the assembly of circuit board characters (sign) 20, a third conductor may be used to bond the enclosure 40 to ground.

In applications where a direct current (DC) power source is used to power the circuit board assembly 20, many types of power sources may be used. The wiring harness connector 66 can be configured to attach to various types of power sources. Examples of the power sources the connector 66 may be configured to attach to are; an automotive battery or power system, an AC to DC adapter, an outside low voltage lighting system transformer. The connector 66 may also be sealed when used in outdoor applications.

The enclosure 40 has end panels 30 attached to end of the enclosure. The end panels 30 may be attached with various means, such as adhesive, snaps, press fits or with fasteners. In the preferred embodiment, the end panels 30 are attached to the enclosure 40, using screws 33. The screws pass through the end panel attaching holes 32 and tap into the integral screw boss 46, in the enclosure 40. In applications that require the circuit board cavity 54 to be sealed, a seal 28 can be placed between the end panel 30 and enclosure 40. When the screws 33 are tightened to attach the end panel, their clamp load compresses the seal 28.

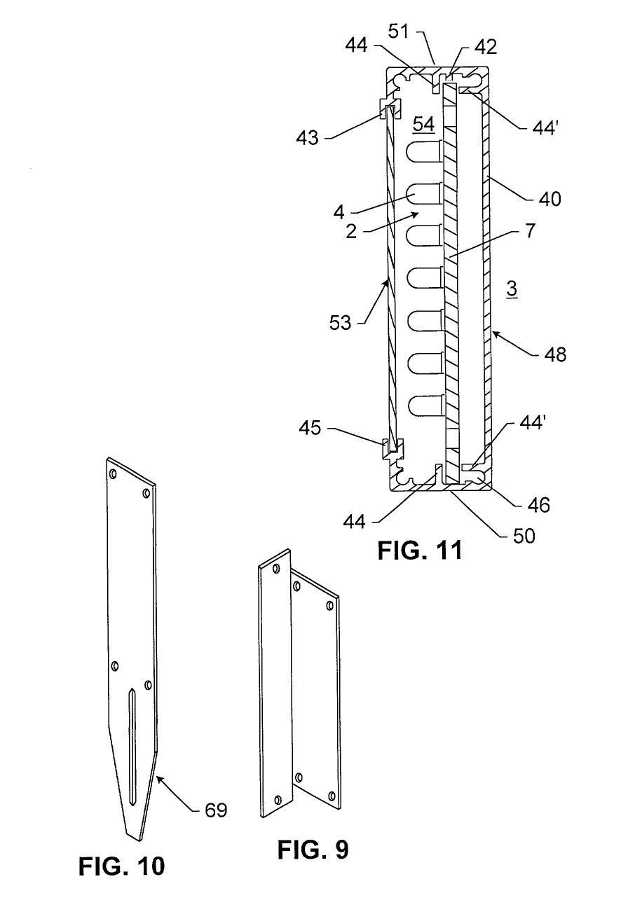

Referring now to FIG. 3, the end panels 30 have details used for stacking and mounting the signs. The end panel 30 has an offset flange 37. The offset flange 37 has a hole 39 through which a hook 26 can be looped for hanging the display system 3. The hook 26 can be used in conjunction with a suction cup 25 to attach the display system 3 to various glass panels such as house or automotive windows. In an alternative construction, the end panels may be configured in a “L” shape (FIG. 9) and mounted to a vertical panel. The offset flange 37 and it's integral mounting holes 32′ can also be used to stack display system 3 panels on top of one another to form multiple rows. The end panel bottom mounting holes 32 are aligned with the offset flange 37 mounting holes 32′. The end panel attaching screws 33 are than attached to the enclosure screw boss 46 through the holes 32 and 32′, clamping the assembly together. A “L” bracket 56 (FIG. 8) can be mounted in a similar fashion to the bottom of the end panel 30. The screws 33 are driven through “L” bracket 56 attaching holes 58 and end panel bottom attaching holes 32 into the enclosure screw boss 46. The display system 3 can then be mounted on a horizontal plane using mounting holes 57. In yet another configuration of the end panel 30, stakes 69 may be attached to, or formed a part of, the end panel 30. The stakes 69 are used in applications where the display system 3 is to be placed outside and staked into the ground. Depending on the configuration of the end panel 30, it could be made from many different materials. It could be made from plastic and molded with any combination of the details as described above. It could also me made of metal which has been stamped and formed.

In addition to the general description and many uses for a display system 3 as described above, there are several specific applications that warrant further discussion. The display system 3 (FIG. 2) can be configured with end panels 30, suction cups 25, hooks 26 and a connector 66 which connects to a AC/DC adapter. The display system 3 can than be mounted to a window to visibly display the street address of a house or building. The same configuration with a connector 66 or wires that connect to an automotive DC power system could attach to a window in an automobile. In another configuration, the display system 3 can be configured with an end panel 30 (FIG. 9) configured to mount directly to the automotive license plate mounting points. This display system 3 could be used for displaying a name or message on the front license plate mount of an automobile. Yet another configuration of the display system 3 could use end panels 10 and a connector 66 or wires which connect to a low voltage lighting system. The display system 3 could display the street address or other message and be powered when the low voltage system is energized.

In an optional configuration, the circuit board display characters 2 can be used without the enclosure and mounted to a large panel (not shown). This configuration may be used for multiple line signs that can be easily configured using the display characters 2.

In accordance with the provisions of the patent statutes, the present invention has been described in what is considered to represent its preferred embodiment. However, it should be noted that the invention can be practiced otherwise than as specifically illustrated and described without departing from its spirit or scope.

What I claim as my invention is:

1. A configurable lighting display device comprising:
a plurality of electrical circuit boards with a plurality of light emitting diodes placed in a configuration on each circuit board to form a different alphanumeric character on each of the said circuit boards; and
a conductive metallic trace on said circuit boards that bus electrical power to one or more circuits where said light emitting diodes are electromechanically connected to said trace; and
a conductive metallic trace on said circuit boards that bus electrical ground from said light emitting diode circuits; and
a means for electromechanically connecting power and ground to said conductive traces on said circuit boards;
whereby said circuit boards can be arranged to form words, numbers or combinations of words or numbers. When power and ground are applied to their respective bus on said circuit boards, the said light emitting diodes are energized and light displaying said words and/or numbers.

2. The configurable lighting display device according to claim 1 including a conductive metallic trace which bus electrical power from one edge of said circuit board to the opposite edge of said circuit board.

3. The configurable lighting display device according to claim 2 including;
a set of holes at each end of said metallic trace for electromechanically connecting abutting circuit boards with a conductive bus bar or connector; and,
a conductive bus bar which bridges the gap between two circuit boards and is electromechanically attached to said conductive traces on each of the circuit boards;
whereby, when said character circuit boards abut one another and they are electromechanically connected to one another by said bus bar, electrical power is passed from board to board along the conductive trace and conductive bus bar and energizes the respective alphanumeric character on each board.

4. The configurable lighting display device according to claim 2 including a conductive electrical connector terminal which electromechanically connects abutting circuit boards, whereby, conducting electrical power from board to board along the conductive trace and through said connector which energizes the respective alphanumeric character on each board.

5. The configurable lighting display device according to claim 3 including an enclosure with a clear lens that encases the circuit board assembly.

6. The configurable lighting display device according to claim 4 including an enclosure with a clear lens that encases the circuit board assembly.

7. The configurable lighting display device according to claim 1 which is powered by a direct current power system.

8. The configurable lighting display device according to claim 1 which is powered by an alternating current to direct current transformer.

9. The configurable lighting display device according to claim 1 which is powered by an alternating current power supply.

10. The configurable lighting display device according to claim 1 which is powered by a solar voltaic power system

11. The configurable lighting display device according to claim 1 which is used in conjunction with a light sensor to only light the said display device when it is dark.

12. The configurable lighting display device according to claim 5 from which the enclosure is made from an extrusion which can be cut to any length for displaying different length messages and with end panels to enclose the circuit board assemblies.

13. The configurable lighting display device according to claim 6 from which the enclosure is made from an extrusion which can be cut to any length for displaying different length messages and with end panels to enclose the circuit board assemblies.
